(19) United States
(12) Patent Application Publication
(10) Pub. No.: US 2002/0195446 A1
(43) Pub. Date: Dec. 26, 2002

(54) Railroad frog reconditioning and welding table and method of use

(76) Inventor: Christopher A. Galloway, Plaistow, NH (US)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/173,149

(22) Filed: Jun. 18, 2002

Related U.S. Application Data
(60) Provisional application No. 60/299,722, filed on Jun. 22, 2001.

(51) Int. Cl. H05B 6/22

(52) U.S. Cl. 219/652

(57) ABSTRACT

A railroad frog positioning and reconditioning table features a table in the form of a rotating I-beam structure having an integral tube set off-center and resting in two pillow block bearings attached to pedestal that are bolted to a concrete floor at opposite ends of the table. One pedestal holds a worm gear reducing case that allows the table to rotate by the turning of a 12 inch hand wheel. The bottom of the table is capable of containing counterweights that, along with the off-center spacing of the support shaft, enable the table to become counterbalanced when a frog is secured to the top of the table. This counterbalance allows the table to be rotated with a minimum of effort. The size of the weights is designed to allow ample counterbalance for a large variety of frog sizes. Multiple pairs of ears are attached to the sides of the table integrated with stiffener supports to provide tie-down points for creating the proper frog deflection. The table may be configured to handle one or more frogs up to a combined total of 35 feet in length and a combined weight of up to 18,000 pounds.

The present application claims priority of U.S. Provisional Application Serial No. 60/299,722, filed Jun. 22, 2001, entitled “Railroad Frog Reconditioning and Welding Table and Method of Use”, the disclosure of which is incorporated by reference herein in its entirety.

### TECHNICAL FIELD

The present invention relates generally to machines for reconditioning railroad frogs and, more particularly, to machines for movably supporting one or more railroad frogs to facilitate welding repair thereof.

### BACKGROUND ART

In the railroad industry, the basic parts of a turnout or track switch are a frog, a switch, guard rails (when required), and a switch stand. The frog is therefore an integral load supporting component of the railroad track switch. The frog component allows the train wheels to move across the plane of the normal running rail during the diverging move through a switch. When a train undergoes a diverging move over a switch, the switch points steer the wheels towards the new direction and the frog creates the gap in the normal running rail to allow the wheel flanges to pass therethrough. To assure a smooth transition over this gap, the frog is constructed with risers and an inclined point to reduce, as much as possible, the impact of the wheels as they pass over the gap. The physics of the action of the wheel passing over this gap requires this component to be constructed of a material that can withstand both the abrasion wear of the train wheels rolling over the frog and the impact resistance of each wheel as it bridges the gap.

Manganese steel is the material used in the construction of railroad frogs due to its work hardening capabilities that resist abrasion wear and stand up well under heavy impact loads. With reference to FIGS. 1-3, the manganese steel is cast into an insert generally designated by reference numeral 10, which is bolted to and surrounded by regular heat treated railroad steel that allows the frogs to be installed in the track structure. Manganese steel can also be used as a complete casting for self guarded frogs which are molded to allow these frogs to be free standing and bolted directly into the track structure.

For example, at one end of frog F, a pair of toe rails 12 and 14 converge towards each other and extend around outer surfaces of a throat portion 16 of the insert 10. These toe rails 12 and 14 are regular heat-treated railroad steel that are mounted to a plurality of railroad ties 15 in a conventional manner and are spaced from each other with a toe block 17 made of cast iron or ductile iron (see FIG. 3A) in an upstream direction from throat portion 16 with a nut and bolt arrangement 19. The throat portion 16, with reference to FIGS. 2 and 3, is molded to define a pair of longitudinally outwardly converging riser sections 21 of insert 10 (see also FIG. 3C) having a pair of inward facing chamfered surfaces 23 in longitudinal alignment with the corresponding support surfaces of the rail heads to define the guideways or flange ways that enable the rail flanges to pass from the toe rails to the gap formed in throat portion 16 of the insert 10 and then into supporting rolling contact with the chamfered surfaces 23. At a point further downstream from the point 25 defining the center portion 27 of the insert 10 (see FIGS. 3D and 3E), the forwardmost ends of a pair of heel rails 29 also of regular heat-treated railroad steel and conventionally mounted to appropriately positioned railroad ties are positioned to continue the flange ways on which the rail wheels are adapted to be supported as they traverse the gap.

The frogs F are subject to wear during normal railroad service and can be maintained in the track to some extent by grinding and performing various amounts of field repair welding as track conditions will allow. However, on a periodic basis, there is a need to remove these frogs from the track environment for rebuilding. Although in some cases it is more economical to simply replace a damaged frog with a new frog, there are many obsolete rail sizes in various commuter rail systems and, particularly in these situations, it becomes more economical to conduct major rebuilding or reconditioning operations on such damaged frogs.

The proper restoration of a damaged frog requires extensive welding restoration of the frog F on the running surface or top of the frog in order to remove defects and fatigued metal and to build the manganese to the original cross section such as shown in FIGS. 3B-3G. This type of heavy welding necessitated a fixture on which the frogs F were secured during the welding operation. Moreover, this type of heavy welding causes the entire frog structure to curve upward as a result of intense heat-generated during the welding process. Therefore, it was and is necessary to secure each frog F with a slightly concave deflection to offset this warping tendency.

With reference to FIG. 4, the conventional prior art table structure 30 for supporting the frog F during the welding operation was comprised of a plurality of regular heat-treated steel railroad rails 32 of 15 foot length in which longitudinal edges 34 of adjacent rail bases were welded together base side up in an effort to form a flat support surface 36. A support shaft 38 extended through a space formed between adjacent centrally located rails in which opposite ends of the shaft were received in bearing collars 40 mounted on support pedestals 42.

The foregoing prior art structure 10 suffered from various drawbacks. For example, the prior art table 10 was not level and the support rail assembly 32 had insufficient stiffness to hold the frog F in the concave deflected position. Consequently, after clamping of the frog F at its opposite ends to the table 10 to initiate the slightly concave frog deflection, this deflection force was often transmitted to the table which then deflected as well resulting in a disadvantageously upwardly curved frog following heavy welding and release from the table.

In addition to the foregoing problems, when rebuilding a frog insert casting 10, after the top surface of the frog is restored with heavy welding material, it is then necessary to rebuild the flange ways 23 with welding material. However, due to the shape of the frog casting, with its deep flange ways 23, it becomes highly advantageous to rotate the frog casting through 90° about its longitudinal axis L in order to horizontally position the flange way 23 to properly conduct this build-up welding. Otherwise, due to the narrowness of the flange ways 23, it is difficult to attain the proper electrode angle. This leads to depositing more metal than is actually needed and necessitates additional time to grind the repaired surface to the proper contour. To reposition the frog in this manner, the prior art frog table 10 depicted in FIG. 4 was rotated using a crane or fork truck with wood blocking then needed to support the table in the turned position. Disadvantageously, this added time and necessitated some degree of difficulty in switching the frog from one position to another position. Since different size frogs must be positioned on this prior art frog table for reconditioning, the table also experienced imbalance and instability while being rotated to different rest positions.

It is accordingly an object of the present invention to support frogs for reconditioning on a level surface.

Another object is to support frogs on a level support surface that is sufficiently stiff in order to hold the frog in a deflected position during heavy welding.

Another object is to be able to rotate the stiff and level table supporting surface along a longitudinal axis thereof through a range of 180 degrees of lateral positioning with minimal manual effort.

Still another object of the invention is to employ effective locking devices to safely and securely hold the table in different angular orientations.

Yet another object is to provide a table surface that can hold a wide range of different frog lengths and rail sections.

### DISCLOSURE OF THE INVENTION

A railroad frog reconditioning and welding table, in accordance with a preferred embodiment of the present invention, comprises a table including a pair of longitudinally extending support beams and a stiffener plate assembly including a plurality of transversely extending stiffener plates attached to the support beams at longitudinally spaced intervals from each other. A pair of clamping members are adapted to be operatively connected to the table for clamping the frog at opposite ends thereof by applying a clamping force directed downwardly towards the support beams. Preferentially, a spacer bar is adapted to be placed between a center portion of the frog and the support beams to impart upward longitudinal deflection of the frog center in cooperation with the clamped ends thereof.

The foregoing reconditioning and welding table provides a robust construction capable of resisting any tendency to warp or ‘banana’ when the frog is clamped to the table and deflected in order to itself resist a tendency to banana that would otherwise occur as a result of the heat imparted to the frog during the heavy welding restoration process. In the prior art, less robust reconditioning and welding table constructions experienced undesirable deflection as a result of deflection forces transmitted thereto from the railroad frog loaded in longitudinal deflection. The present invention avoids these prior art problems.

In the preferred embodiment, the pair of support beams includes a pair of I-beams extending in parallel spaced relation to each other. Each stiffener plate is of rectangular configuration having cut out corners dimensioned to interfit with an inwardly extending flange of an associated one of the I-beams so that the upper and lower edge surfaces of the plate are respectively coplanar with associated upper and lower surfaces of adjacent I-beam flanges. The cut out corners may be further configured so that side edges of the stiffener plate extending between the upper and lower edge surfaces are in full contact with inwardly facing surfaces of the associated I-beam web extending vertically between the flanges. Preferably, all contact edges between each stiffener plate and I-beam are welded to ensure such robust construction.

A support member in the form of a heavy steel top plate is preferably secured to the I-beam upper surfaces to define an upwardly directed table support surface thereon. The top plate is not necessarily an integral reinforcement component of the robust table construction in which the longitudinally extending support beams in combination with the stiffener plate assembly are being essentially relied upon to provide a stable flat working or clamping surface resisting longitudinal deflection forces as discussed above.

The reconditioning and welding table of the present invention, in accordance with another feature, further comprises a support shaft extending longitudinally through the stiffener plate assembly. A pair of bearings are located at opposite ends of the support shaft in rotary supporting engagement therewith. A rotating arrangement is operatively connected to at least one and preferably both of the ends of the support shaft for enabling controlled rotation of the table about the longitudinal axis of shaft rotation. This rotation enables the table and frog being worked upon to rotate to different angular positions so as to enable workmen to have easier access to surfaces of the frog being reconditioned (e.g., flange ways formed in the manganese steel insert of the frog) that are not easily accessed when the table is in the horizontal position.

The rotating arrangement may embody different forms, such as a gearing arrangement, preferably a reducing gear arrangement having a worm gear reducing case operatively connected to a hand wheel for rotating the table. In other embodiments, the rotating arrangement may include an electric or other type of powered motor, a belt drive arrangement, etc.

The bearings are preferably pillow block bearings attached to a respective support pedestal adapted to be positioned on a floor supporting surface.

The feature of providing a hand wheel and worm gear arrangement enables the workman to easily rotate the table into a selected angular position to perform the further work. Once in a predetermined angular orientation, such as 45° or 90°, the table may be easily locked into this position by means of a unique locking device operatively connected to selectively lock the table at predetermined angular orientations. In one embodiment, the locking device may be a pin type locking device installed at one or both ends of the table. The pin type locking device may include a circumferentially extending plate or collar bolted to one of the shaft ends for rotation therewith about the rotational axis. This movable collar moves in a transverse plane parallel to a locking plate fixedly bolted to the support pedestal in adjacent outwardly spaced relationship from the pillow block bearing. The fixed locking plate is formed with a series of circumferentially spaced longitudinally axially extending openings adapted to become aligned with a corresponding opening formed in the collar as the shaft and table rotate. In this manner, a locking pin may be inserted through the collar movable opening when it is selectively aligned with one of the locking plate openings to easily secure the table in its predetermined angular orientation in a safe and reliable manner. It will be understood that the aforementioned pin type locking device is located within easy reach of the hand wheel.

The stiffener plates are preferably located at longitudinally spaced intervals that are coincident with the tie-down attachment ears to thereby provide stiffening reinforcement particularly in the vicinity of the clamping points along the table. In addition, the support beams are preferably pre-stressed so that the table is slightly arched in the absence of supporting a load thereon. This pre-stressing enables the table to resist undesirable longitudinal deflected when one or more frogs are bolted the table.

A method of reconditioning a railroad frog is also disclosed. In accordance with the invention, the reconditioning method comprises the steps of positioning the frog on the support table and then spacing a center portion of the frog upwardly from the table support surface. Opposite ends of the frog are clamped against the table. Reconditioning of damaged areas of the frog then occurs by removal of the damaged areas and replacement with a filling material in the form of a weld material deposited by welding into the space formerly occupied by the damaged area. The table is then rotated about a longitudinal axis from a horizontal position to a different angular orientation and a pin type locking device is utilized to securely lock the table into the different angular orientation to enable reconditioning work to continue.

Preferentially, the frog is positioned on a support table that is pre-stressed to arch upwardly in the absence of a load and to then become substantially horizontal under the weight and clamping loading forces being imparted to the frog.

The table is preferably rotated by manual operation of a hand wheel.

The method also comprises the further step of attaching counterweights to a bottom portion of the table before rotating the table into a different angular orientation.

Before the frog is positioned on the table, the method of the invention preferably features the further step of grinding upper surfaces of the frog so as to remove work hard material that has become brittle and cracked. Preferably, the frog is positioned upon a roller conveyor at a grinding station. The grinding station conveyor is operatively mounted beneath a grinding machine that has been mounted to a wheel carriage. The wheel carriage may be moved along wheel supporting surfaces on opposite sides of the roller conveyor to enable grinding wheel contact with the damaged areas along the entire length of the frog.

After grinding the frog is roll conveyored to the vicinity of the reconditioning and welding table. A crane may then be used to lift the frog onto the table for clamping reconditioning.

The opposite ends of the frog, after positioning on the table, are clamped by positioning a transversely extending bar over the associated end of the frog, followed by inserting a clamping bolt through the clamping bar into threaded engagement with a clamping nut located at opposite sides of the table at selected tie-down points. After reconditioning is completed, the nuts may be removed from the tie-down points. This removable nut feature facilitates the further use of the tie-down points in subsequent machining applications. One such machining application, in accordance with the invention, involves the milling of the refinished surfaces of the frog with a milling machine that is operatively mounted to the reconditioning and welding table for milling movement in relation to the frog in the longitudinal direction. To achieve relative movement of a milling head with respect to the frog, the milling machine is bolted to the table through the tie-down points.

In accordance with another method feature of the invention, a method of reconditioning a railroad frog comprises the steps of providing the reinforced support table having an upward or natural flexure in the absence of any load thereon. The frog is positioned on the support table and a center spacer bar is disposed between the frog and the table support surface. The opposite ends of the frog are clamped to the table and, as a result of the center spacer bar, the frog is longitudinally deflected away from the table at its center. Reconditioning of damaged areas of the frog then occurs by removal of the damaged areas and replacement with weld material in a welding process. The thickness of the table and the natural flexure built into the table is operable to ensure that the reconditioned frog is substantially straight and level at the completion of reconditioning, notwithstanding the extreme heat imparted from the frog into the table during the heavy welding restoration process.

It is to be understood that the frogs being reconditioned, which are essentially a combination of heat-treated steel rails bolted to a manganese steel heavy insert, are structures that typically weight upwards of 8,000 pounds that require balancing when rotated to different angular positions about the shaft axis. For that purpose, the support shaft is preferably positioned so that its longitudinal axis of rotation is located above an imaginary horizontal center plane bisecting the support beams in relation to the beam height. More specifically, the support shaft is positioned so that its axis of rotation is located above the center of gravity of the table structure. This off-center positioning facilitates the use of a counterweight arrangement that may be secured to a bottom portion of the table located below the center of gravity so as to counterbalance the table in cooperation with this off-center shaft spacing when a frog is clampingly secured to the top of the table.

Clamping is performed by means of a clamping bar dimensioned to extent transversely across the table width and which is adapted to receive downwardly projecting clamping bolts through bolt receiving openings at opposite ends thereof. These bolts are dimensioned to extend downwardly from the clamping bars respectively into a pair attachment ears fixed to the sides of the table to provide tie-down points that enable the clamping members to be attached to the table. In the preferred embodiment, each ear is reinforced with a pair of reinforcement gussets attached to an associated one of the support beams in parallel longitudinally spaced relationship to each other. The ear extends between the gusset pairs and a threaded clamping nut is provided between the gussets in operative alignment with the clamping bolt. In the preferred embodiment, the clamping nut is a removable nut that is dimensioned to interfit in a cavity formed between the gussets and beneath the ear whereby inward facing surfaces of the gusset restrain rotation of the removable nut as the clamping bolt is threaded into tight clamping engagement therewith.

Still other objects and advantages of the present invention will become readily apparent to those skilled in this art from the following detailed description, wherein only the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawing and description are to be regarded as illustrative in nature, and not as restrictive.

### BRIEF DESCRIPTION OF THE DRAWINGS

FIG. 1 is a perspective view of a rail bound manganese steel frog with a light type insert or center as recommended for light and medium heavy traffic service;

FIG. 2 is a top plan view of the frog depicted in FIG. 1;

FIG. 3 is a scaled top plan view of a rail bound manganese steel frog similar to the frog depicted in FIG. 2;

FIG. 3A is a sectional view taken along section line 3A-3A of FIG. 3;

FIG. 3B is a sectional view taken along line 3B-3B of FIG. 3;

FIG. 3C is a sectional view taken along line 3C-3C of FIG. 3;

FIG. 3D is a sectional view taken along line 3D-3D of FIG. 3;

FIG. 3E is a sectional view taken along line 3E-3E of FIG. 3;

FIG. 3F is a sectional view taken along line 3F-3F of FIG. 3;

FIG. 3G is a sectional view taken along line 3G-3G of FIG. 3;

FIG. 4 is a perspective view of a prior art frog table;

FIG. 5A is a perspective view of a frog reconditioning workshop utilizing frog positioning and welding tables in accordance with the present invention;

FIG. 5B is an enlarged perspective view of one of the frog tables of FIG. 5A;

FIG. 6 is a perspective view of a grinding station for initially processing defective areas of a frog to be reconditioned before the frog is placed on the frog table;

FIG. 7 is a perspective view depicting the manner in which the table is reinforced in accordance with the invention;

FIG. 8 is a perspective view depicting other features of the table; and

FIGS. 9A-9C are side and top views depicting removable tie-down nuts for use with the frog table of the present invention.

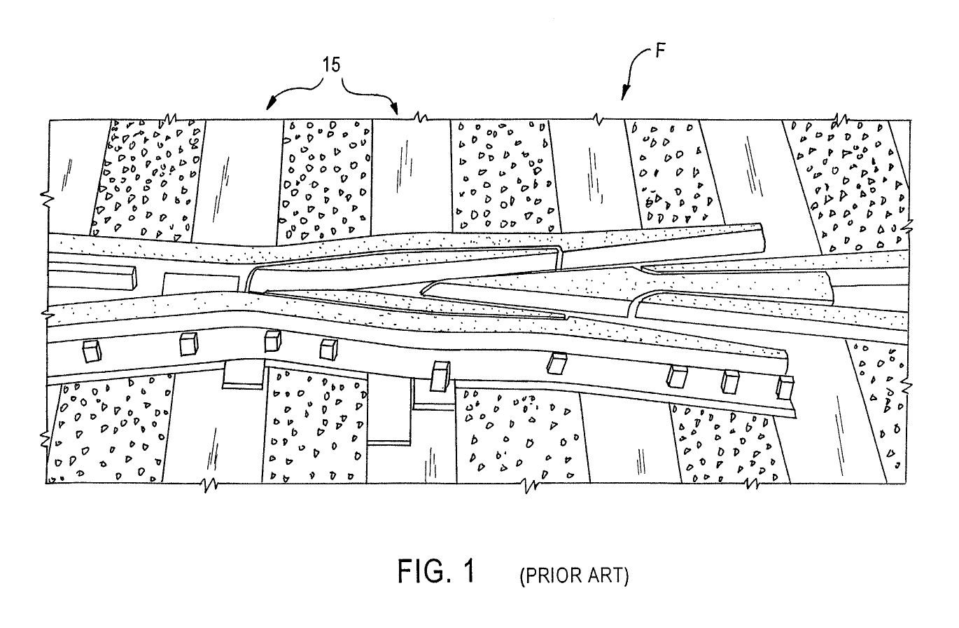

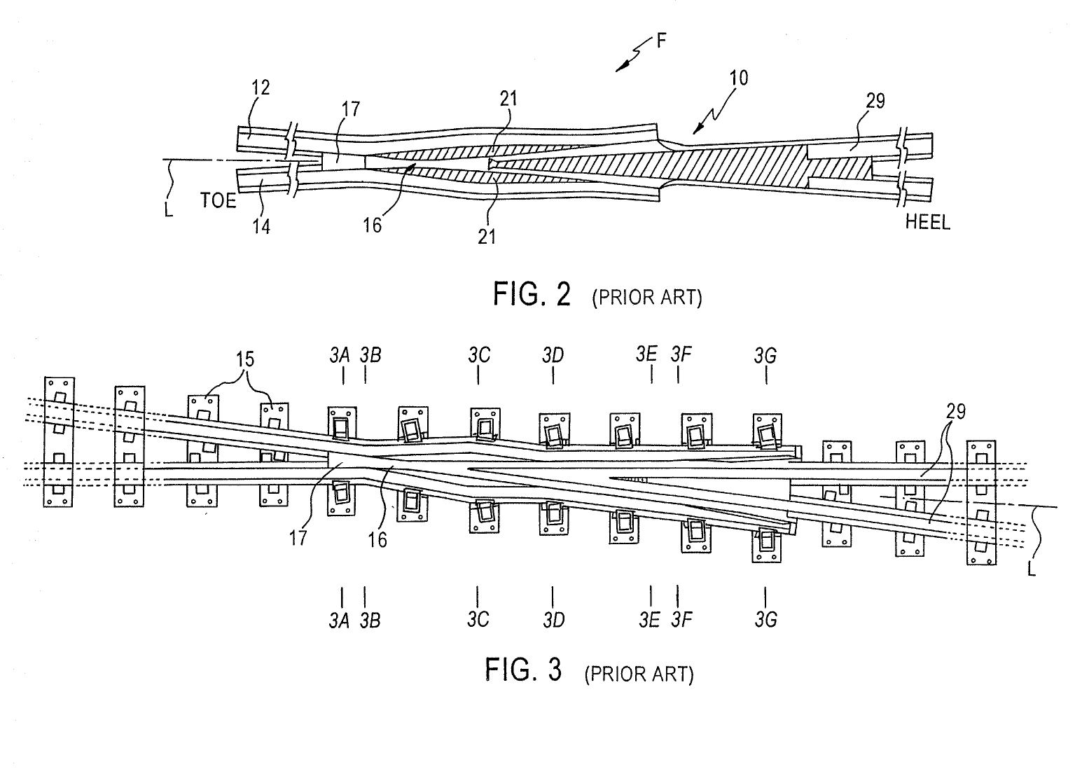

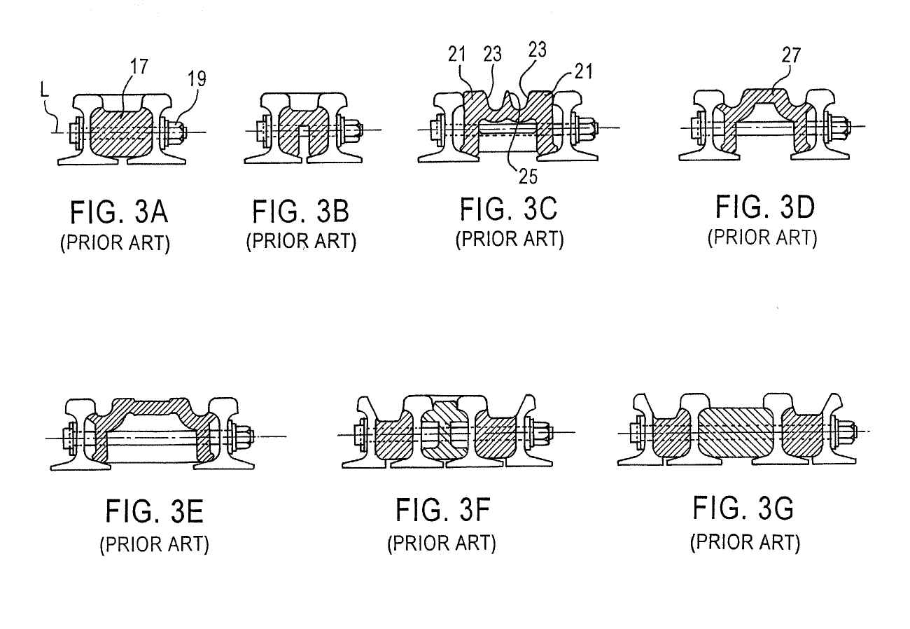

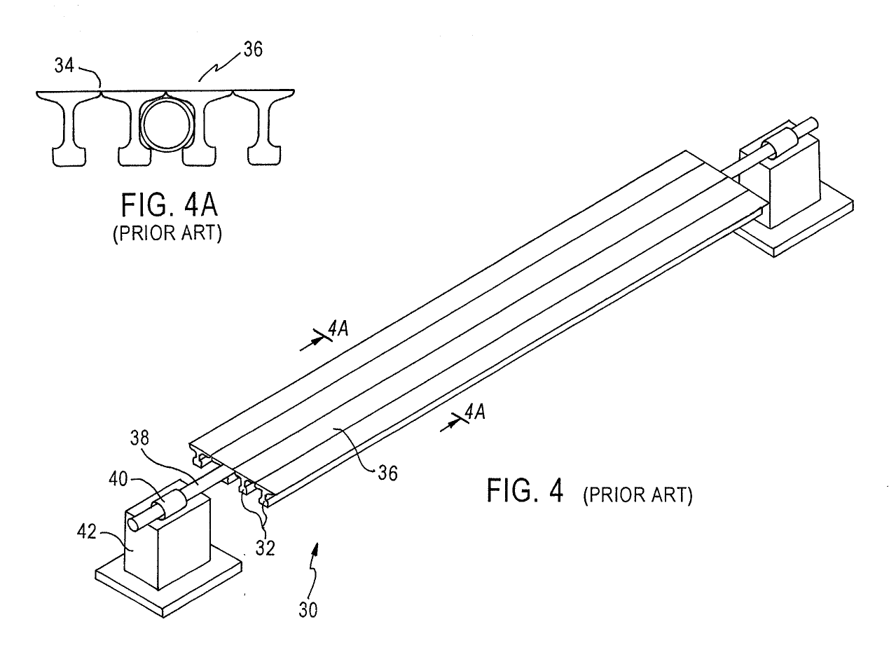

### BEST MODE FOR CARRYING OUT THE INVENTION

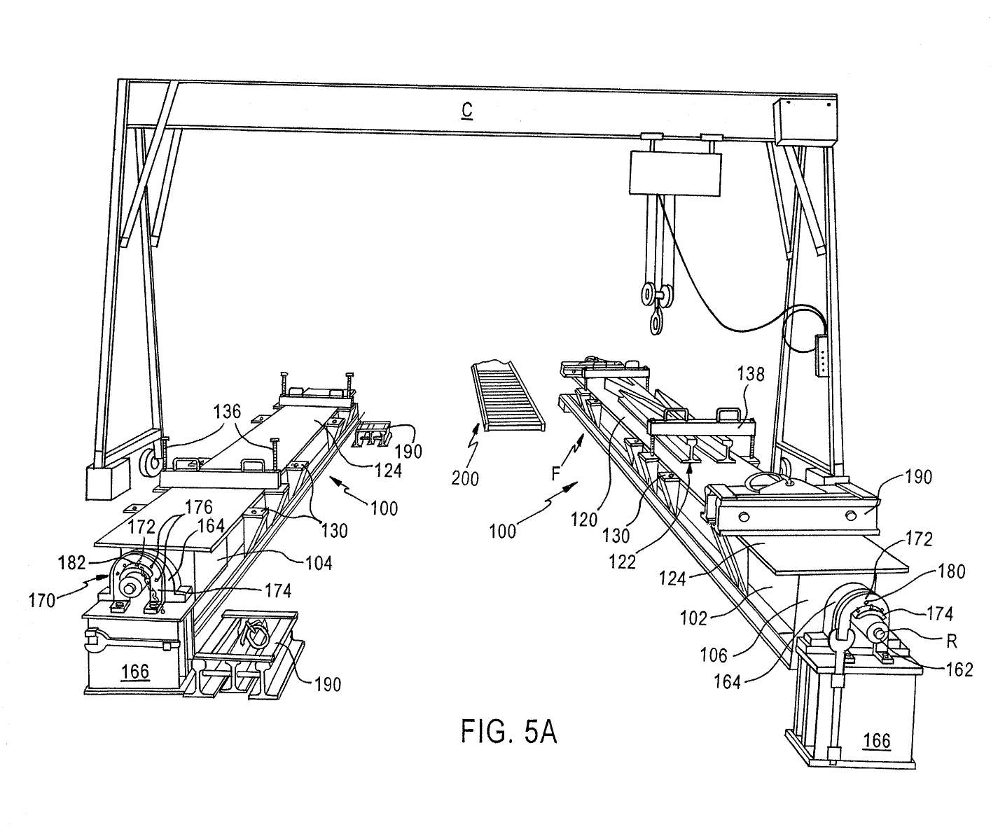

FIGS. 5A and 5B are perspective view illustrations of a unique rotating frog table, generally designated with reference numeral 100, that is designed to support and secure various lengths and weights of frogs F during heavy welding as required during the frog restoration process, without undergoing any internal deflection itself.

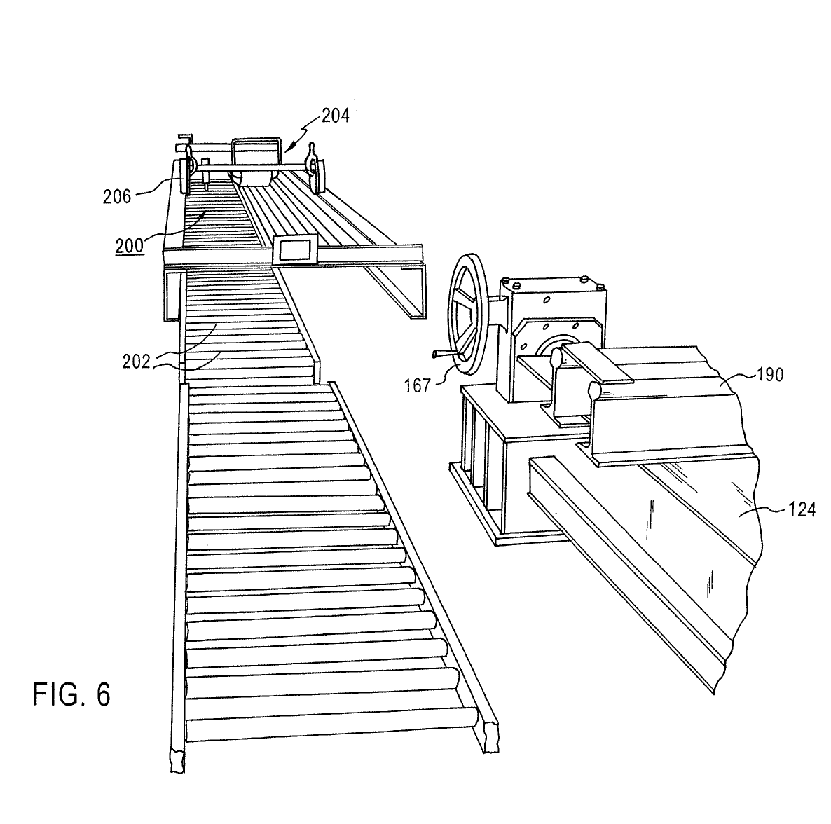

Table 100, in one preferred embodiment, is comprised of a pair of parallel I-beams 102 and 104, each preferably extending the full length of the table. The I-beams 102,104 are connected to each other through a series of identical transverse rectangular steel stiffener plates 106 that are located at longitudinally spaced intervals along the full table length. Each stiffener plate 106 has cut out corners 107 (see FIG. 7) that enable the vertical edges 108 of the plate and the cut edges 110 and 112 defining each corner to fully contact the inner surfaces 114 of both the I-beam web 116 and inwardly extending flange 118 in welded or other secure engagement therewith. It is this basic skeletal support structure that forms the heart of the novel table 100 of this invention enabling the table to remain straight and level by resisting flexion forces that occur when the frog F is clamped to the table supporting surface by means of a center spacer bar 120 and clamped ends 122 on opposite longitudinal sides thereof.

The table top is preferably a top plate 124 that is welded to the top surfaces of I-beams 102,104 and coelevational top and bottom edge surfaces of the transverse stiffener plates 106. In the preferred embodiment, the table top plate 124 may be ¾ inch steel plate that is two feet in width.

Due to the robust construction of the unique arrangement of I-beams 102,104 and stiffener plates 106, the table may have a length of up to 35 feet and preferably in the range of 25-35 feet. For example, a table 25 feet long is capable of holding up to a 23 foot frog in deflection. A table up to 35 feet long is capable of holding two suitably sized frogs in longitudinally spaced relationship from each other and which are clamped to the table at the same time for reconditioning and welding repair.

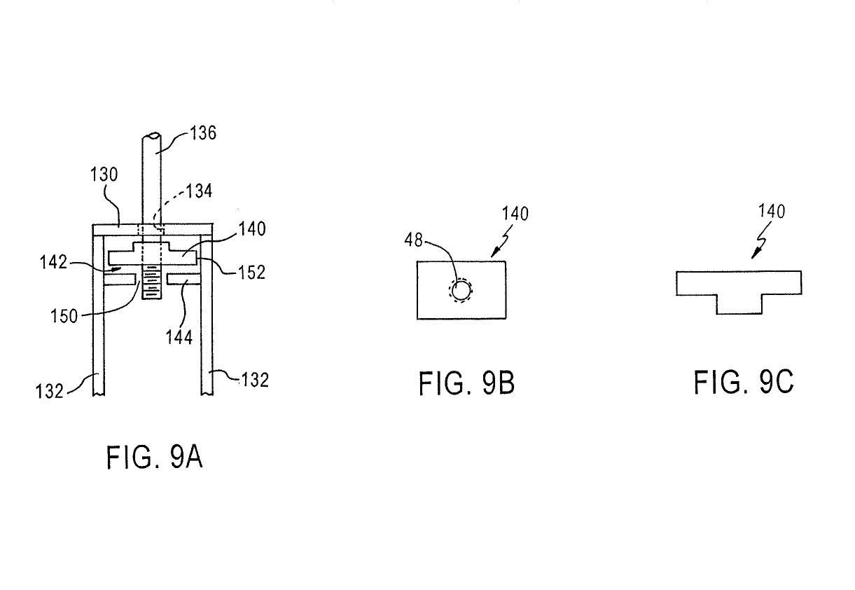

To secure one or more frogs F in clamping engagement with the table, a plurality of pairs of tie-down ears 130 are attached to the sides (I-beam webs 116) of the table, preferably at the same longitudinally spaced intervals as the stiffener plates 106. In the preferred embodiment, with reference to FIGS. 9A-9B, each attachment ear 130 is a horizontally extending plate of rectangular construction in top plan view that has an upper surface coelevational with the table top surface. The attachment ear 130 extends between a pair of vertically extending, longitudinally spaced gussets 132 secured to the outer surface of the associated I-beam web 118 by welding or other method of secure attachment. An opening 134 formed in the ear 130 is capable of receiving a lower end of one clamping bolt 136 extending downwardly through suitable passages formed at opposite transverse ends of the associated clamping bar 138. A nut may be welded in coaxial alignment with the attachment ear opening to permit threaded engagement with the clamping bolt lower end. However, in the preferred embodiment of this invention, a removable tie-down nut 140 is preferably disposed in a cavity 142 formed between inward facing surfaces of the gussets 132, the bottom surface of the attachment ear 130 and the upper surface 144 of a retaining plate that is both parallel and below the attachment ear in welded engagement with the gusset (see FIG. 9A). This arrangement enables the removable nut 140 to be received in the cavity. The removable nut 140 depicted in FIGS. 9B and 9C has a threaded central opening 148 adapted to receive the lower end of the clamping bolt 136 in threaded engagement. A coaxially aligned opening 150 in the bottom plate 144 enables the clamping bolt 136 to extend therethrough as the bolts are screwed to apply clamping force exerted by the clamping bar 138 against the associated frog end. Opposite parallel edges 152 of the removable nut 130 are preferably slightly spaced inwardly from the inward facing surfaces of the gussets 132 so that the gussets prevent rotational movement of the nut as the bolts 136 are screwed into threaded engagement therewith to achieve the aforesaid clamping contact.

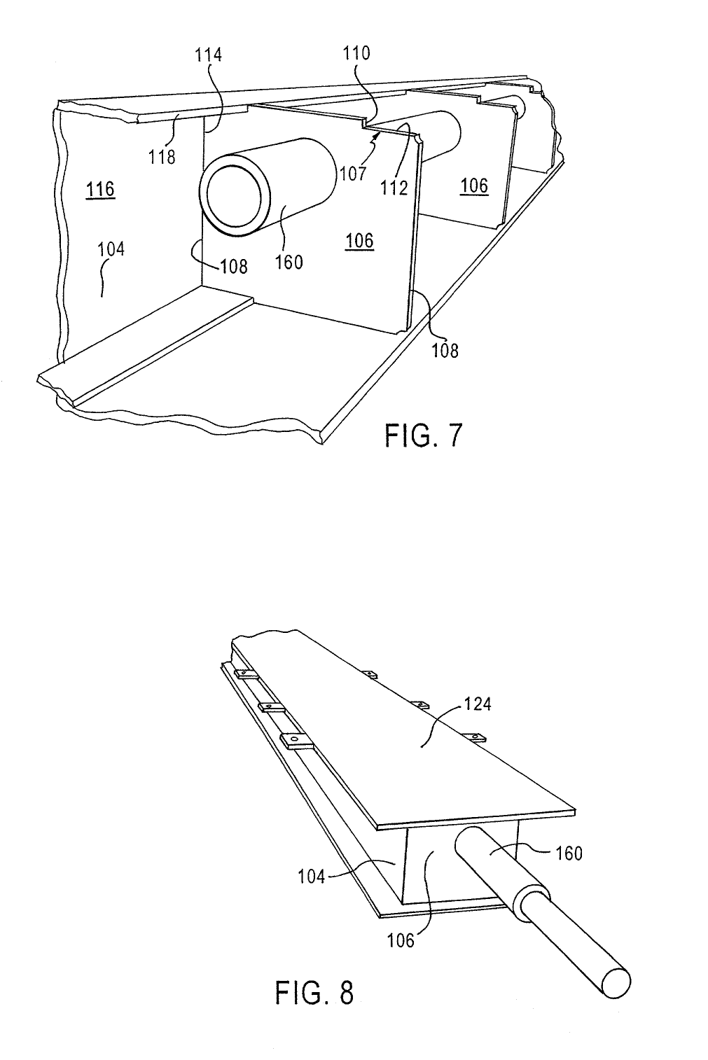

A support shaft 160 extends longitudinally through the stiffener plate assembly (see FIGS. 7 and 8) 106 with opposite ends 162 thereof extending respectively through the end stiffener plates in rotary supporting engagement with a pillow block bearing 164 attached to a support pedestal 166 adapted to be supported by the floor surface as best depicted in FIG. 5A. A rotating arrangement is operatively connected to at least one, and preferably both, of the ends 162 of the support shaft 160 for enabling controlled rotation of the table 100 about the longitudinal shaft rotational axis R. This rotation enables the table 100 and frog F being worked upon to rotate to different angular positions to enable workmen to have easier access to surfaces of the frog being reconditioned (e.g. guideways 32 formed in the manganese steel insert 10 of the frog) that are not easily accessed when the table 100 is in the horizontal position.

Although the rotating arrangement may embody different forms, preferably a reducing gear arrangement in the form of a worm gear reducing case 165 (see FIG. 5B) is operatively connected to one shaft end 16 and a hand wheel 167 for rotating the table 100. In other embodiments, the rotating arrangement may include an electric or other type of powered motor, a belt drive arrangement, etc.

The feature of providing a hand wheel 167 and worm gear arrangement 165 enables the workman to easily rotate the table 100 into a selected angular position to perform the further work. Once in the predetermined angular position (e.g. 45° or 90°), the table 100 may be easily locked into this position by means of a unique locking device operatively connected to selectively lock the table at predetermined angular orientations. In one embodiment, the locking device may be a pin type locking device 170 installed at one or both ends of the table 100. The pin type locking device 170, as best depicted in FIG. 5A, may include a circumferentially extending plate or collar 172 bolted to one of the shaft ends 162 for rotation therewith about the rotational axis R. This movable collar 172 moves in a transverse plane parallel to a retaining or locking plate 174 fixedly bolted to the support pedestal 166 in adjacent outwardly spaced relationship from the pillow block bearing 164. The locking plate 174 is formed with a series of circumferentially spaced longitudinally extending openings 176 adapted to become aligned with a corresponding opening 180 formed in the collar 172 as the shaft 160 and the table rotate. In this manner, a locking pin 182 may be inserted through the collar movable opening 180 when it is selectively aligned with one of the locking plate openings 176 to easily secure the table in its predetermined angular position in a safe and reliable manner. In the preferred embodiment, this pin type locking device is located within easy reach of the hand wheel 167 as is apparent from FIG. 5B.

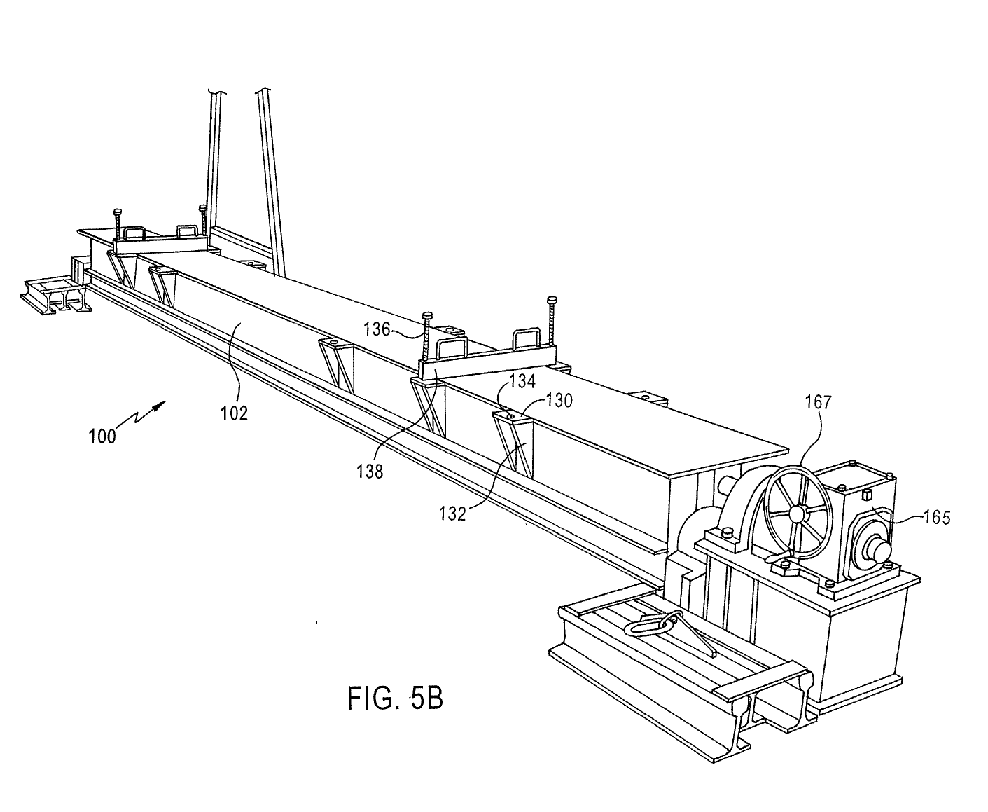

With frog table 100 of the invention, reconditioning of frogs F may now be accomplished in a faster as well as safe and reliable manner. Initially, when the frog F is delivered to the shop for reconditioning, the frog is initially placed in a grinding station consisting of a grinding panel 200 having I-beams, angle irons an a conveyor 202 made out of steel rollers as best depicted in FIG. 6. While on the grinding panel or table 200, the upper surface of the frog to be reconditioned is exposed to a grinding machine 204 preferably mounted on a wheeled carriage 206 for relative movement to enable the work hard material that has become brittle and cracked be grinded from the frog. After grinding, a crane C (FIG. 5A) is used to transfer the frog from the conveyor 200 to the table 100. The spacer bar 120 is placed on the table to contact a center portion of the frog placed thereon. Based on experimentation, a spacer bar of ¾ inch is usually disposed beneath a frog up to 11 feet in length. A one inch spacer bar is used for frogs of 11 to 18 feet in length while a 1¼ inch spacer bar is used for longer frogs or frogs requiring extensive welding.

After being placed on the table, the frog ends are then clamped to the table in the unique manner described above. Welding repair then commences to recondition damaged areas of the frog by removal of these damaged areas and replacement with a welding material.

The table is then rotated with the hand wheel 167 about its longitudinal axis R to approximately 45° or 90° positions where the table is then securely locked with the aforementioned pin locking device 170. In this position, other surfaces of the frog insert requiring reconditioning are now exposed to the workman for ease of repair.

Since the frog is an extremely heavy object, one feature of this invention involves the placement of the rotational shaft 160 at a predetermined location within the table so as to enable counterweights 190 to be attached to the table bottom so that the frog and table may be rotated with the hand wheel. In practice, a pair of counterweights of 350 pounds each are customarily secured to the table bottom such as by bolting or the like.

As mentioned above, the rotating frog table of the invention is of robust construction and may therefore be 25 to 35 feet long. A 25 foot long rotating I-beam table structure in accordance with this invention is capable of holding up to a 23 foot frog in deflection. In this embodiment, this structure has an integral four inch tube set off center and resting in the tube pillow block bearings. The 35 foot length table may operate satisfactorily with a five inch offset steel tube. This latter table, in the preferred embodiment, can handle number 20 frogs up to 35 feet in length that weigh upwards of 18,000 pounds. Preferably, an 18 inch diameter hand wheel is used to turn the table solely with manual application of force.

It will be readily seen by one of ordinary skill in the art that the present invention fulfills all of the objects set forth above. After reading the foregoing specification, one of ordinary skill will be able to effect various changes, substitutions of equivalents and various other aspects of the invention as broadly disclosed herein. It is therefore intended that the protection granted hereon be limited only by the definition contained in the appended claims and equivalents thereof.

What is claimed is:

1. A railroad frog reconditioning and welding table, comprising:
(a) a table including:
(i) a pair of longitudinally extending support beams; and
(ii) a stiffener plate assembly including a plurality of transversely extending stiffener plates attached to the support beams at longitudinally spaced intervals from each other; and
(b) a pair of clamping members adapted to be operatively connected to the table for clamping the frog at opposite ends thereof by applying a clamping force directed downwardly towards the support beams.

2. The table of claim 1, further comprising a spacer bar adapted to be placed between a center portion of the frog and the support beams to impart longitudinal deflection of the frog in cooperation with the clamped ends thereof.

3. The table of claim 1, wherein said pair of support beams includes a pair of I-beams extending in parallel spaced relation to each other.

4. The table of claim 3, wherein each said stiffener plate is of rectangular configuration having cut out corners dimensioned to interfit with an inwardly extending flange of an associated one of said I-beams so that upper and lower edge surfaces of said plate are respectively coplanar with associated upper and lower surfaces of adjacent I-beam flanges.

5. The table of claim 4, wherein said cut out corners are further configured so that side edges of the stiffener plate extending between the upper and lower edge surfaces are in full contact with inwardly facing surfaces of the associated I-beam web extending between the flanges.

6. The table of claim 3, wherein each said stiffener plate is of rectangular configuration having cut out corners dimensioned to interfit with the beam so that side edges of the stiffener plate extending between the upper and lower side surfaces are in full contact with inwardly facing surfaces of the associated I-beam web extending between the flanges.

7. The table of claim 6, wherein said cut out corners are further configured so that they interfit with an inwardly extending flange of an associated one of said I-beams so that upper and lower edge surfaces of said plate are respectively coplanar with associated upper and lower surfaces of adjacent I-beam flanges.

8. The table of claim 5, further comprising a support member mounted to extend above the support beams to define an upwardly directed support surface thereon.

9. The table of claim 8, further comprising a bottom plate mounted to lower surfaces of the support beams to extend beneath the beams and define a bottom thereof.

10. The table of claim 1, further comprising:
(i) a support shaft extending longitudinally through the stiffener plate assembly;
(ii) a pair of bearings located at opposite ends of said support shaft in rotary supporting engagement therewith; and
(iii) a rotating arrangement operatively connected to at least one of said ends of said support shaft for enabling controlled rotation of said table about the longitudinal axis of rotation of said shaft.

11. The table of claim 10, wherein said rotating arrangement includes a gearing arrangement.

12. The table of claim 11, wherein said gearing arrangement is a reducing gear arrangement.

13. The table of claim 12, wherein said reducing gear arrangement is a worm gear reducing case operatively connected to a hand wheel for rotating said table.

14. The table of claim 10, wherein said rotating arrangement is a motor.

15. The table of claim 10, wherein said rotating arrangement is a belt drive arrangement.

16. The table of claim 10, wherein said bearings are pillow block bearings attached to a respective support pedestal adapted to be positioned on a floor supporting surface.

17. The table of claim 10, wherein said support shaft is positioned so that its longitudinal axis of rotation is located above an imaginary horizontal center plane bisecting the support beams in relation to the beam height.

18. The table of claim 10, wherein said support shaft is positioned so that its longitudinal axis of rotation is located above the center of gravity of the table structure.

19. The table of claim 18, further comprising a counterweight arrangement adapted to be secured to a bottom portion of the table located below the center of gravity to counterbalance the table in cooperation with the off-center spacing of the shaft when a frog is clampingly secured to the top of the table.

20. The table of claim 1, further comprising a plurality of pairs of attachment ears attached to the sides of the table to provide tie-down points enabling the clamping members to be attached to the table at selected locations.

21. The table of claim 20, wherein each ear is reinforced with a reinforcement gusset attached to an associated one of said support beams.

22. The table of claim 19, further comprising a locking device to selectively lock the table at predetermined angular orientations.

23. The table of claim 22, wherein said locking device is a pin type locking device and said angular orientations include 45° and 90° angle in either rotational direction.

24. The table of claim 23, wherein said pin type locking device is installed at both ends of said table.

25. The table of claim 21, wherein each ear is reinforced with a pair of longitudinally spaced said gussets.

26. The table of claim 25, further comprising a removable tie-down nut adapted to be placed in a cavity formed between the associated gussets in said pair and beneath the attachment ear extending between upper portions of said gussets.

27. The table of claim 26, wherein said removable nut is rectangular in plan view and is formed with a threaded opening, wherein opposite parallel edges defining a part of the nut exterior are dimensioned to interfit between interior surfaces of the adjacent gussets and into the cavity and which parallel edges resist rotation of the nut during tightening of the clamping bolt by coacting with said interior surfaces.

28. The table of claim 10, further comprising a leveling device attached to the table.

29. The table of claim 10, wherein said shaft has an outer diameter of four to five inches and a wall thickness of ⅜-⅝ inch.

30. The table of claim 3, further comprising a plurality of longitudinal beams bolted to the underside of the I-beams to increase the amount of mass in a lower portion of the table.

31. The table of claim 20, wherein said stiffener plates are located at intervals coincident with the tie-down attachment ears to thereby provide stiffening reinforcement particularly in the vicinity of the clamping points along the table.

32. The table of claim 3, wherein said support beams are pre-stressed so that the table is slightly arched in the absence of supporting a load thereon.

33. A railroad frog conditioning and welding table, comprising:
(a) a table having a support surface for receiving the frog;
(b) a shaft extending through the table to define a longitudinal axis of rotation about which the table can rotate into positions other than a horizontal position; and
(c) a pin type locking device located at at least one end of the shaft protruding from the table, whereby said pin type locking device is operable to provide positive locking retention of said shaft and thereby said table at one of said angular orientations.

34. A method of reconditioning a railroad frog, comprising the steps of:
(a) positioning the frog on the support table;
(b) spacing a center portion of the frog upwardly from the table support surface;
(c) clamping opposite ends of the frog against the table;
(d) reconditioning damaged areas of the frog by removal of said damaged areas and replacement with a filling material in the form of a weld material deposited by welding into the space formerly occupied by the damaged area by welding;
(e) rotating the table about a longitudinal axis from a horizontal position to a different angular orientation; and
(f) locking said table into said different angular orientation with a pin type locking device.

35. The method of claim 34, wherein said frog is positioned on a support table that is pre-stressed to arch upwardly in the absence of a load and to become substantially horizontal under the load of the frog.

36. The method of claim 34, wherein said table is rotated in step (e) by manual operation of a hand wheel.

37. The method of claim 36, comprising the further step of attaching counterweights to a bottom portion of the table before rotating the table in step (e).

38. The method of claim 34, comprising the further step of grinding the upper surfaces of the frog before positioning the same on the support table so as to remove work hard material that has become brittle and cracked.

39. The method of claim 34, comprising the further step of unclamping the frog and securing the frog to the table with locking blocks, and milling the refinished surfaces of the frog with a milling machine that is operably mounted to the table for milling movement in relation to the frog.

40. The method of claim 34, wherein said opposite ends are clamped by positioning a transversely extending clamping bar over the associated end of the frog, followed by inserting a clamping bolt through the clamping bar into threaded engagement with a clamping nut located at opposite sides of the table at the tie-down points.

41. The method of claim 40, comprising the further step of positioning the nuts in alignment with the associated clamping bolt, and removing the nuts from the tie-down point after the reconditioning is completed.

42. A method of reconditioning a railroad frog, comprising the steps of:
(a) providing a reinforced support table having an upward or natural flexure in the absence of any load thereon;
(b) positioning the frog on the support table;
(c) spacing a center portion of the frog upwardly from the table support surface;
(d) clamping opposite ends of the frog against the table; and
(e) reconditioning damaged areas of the frog by removal thereof of said damaged areas and replacement with weld material in a welding process, wherein the thickness of the table and the natural flexure built into the table is operable to ensure that the reconditioned frog is substantially straight and level at the completion of step (d).

43. The method of claim 42, comprising the further steps of
(a) positioning the frog on the support table;
(b) spacing a center portion of the frog upwardly from the table support surface;
(c) rotating the table about a longitudinal axis from a horizontal position to a different angular orientation; and
(d) locking said table into said different angular orientation with a pin type locking device.

44. The method of claim 43, wherein said table is rotated in step (e) by manual operation of a hand wheel.

45. The method of claim 44, comprising the further step of attaching counterweights to a bottom portion of the table before rotating the table in step (e).

46. The method of claim 42, comprising the further step of grinding the upper surfaces of the frog before positioning the same on the support table so as to remove work hard material that has been brittle and cracked.

47. The method of claim 42, comprising the further step of unclamping the frog and securing the frog to the table with locking blocks, and milling the refinished surfaces of the frog with a milling machine that is operably mounted to the table for milling movement in relation to the frog.

48. The table of claim 1, wherein said stiffener plates are welded to the support beams.

49. The table of claim 48, wherein said welded engagement occurs along substantially the entire areas of contact between the stiffener plates and the support beams.

50. The table of claim 21, wherein said attachment ears and reinforcement gussets are welded to each other and to the associated one of said support beams.

51. The method of claim of claim 42, wherein said reconditioned areas are built up approximately ⅛ inch higher than wing rails of said frog.
